(19) United States
(12) Patent Application Publication
(10) Pub. No.: US 2025/0341974 A1
(43) Pub. Date: Nov. 6, 2025

(54) SECURE MEMORY

(71) Applicant: STMicroelectronics International N.V., Geneva (CH)

(72) Inventor: Mark TRIMMER, Coublevie (FR)

(73) Assignee: STMicroelectronics International N.V., Geneva (CH)

(21) Appl. No.: 19/196,189

(22) Filed: May 1, 2025

(30) Foreign Application Priority Data
May 3, 2024 (FR) FR2404663

(51) Int. Cl. G06F 3/06

(52) U.S. Cl. CPC G06F 3/062; G06F 3/0655; G06F 3/0679

(57) ABSTRACT

An electronic device includes a memory with a first group of columns of memory cells and a second group of columns of memory cells. First data that are only accessible to a first module are stored in the first group of columns of memory cells. Second data that are only accessible to a second module, different from the first module, are stored in the second group of columns of memory cells. The first and second groups of columns of memory cells are disjoint.

### PRIORITY CLAIM

This application claims the priority benefit of French Application for Patent No. FR2404663, filed on May 3, 2024, the content of which is hereby incorporated by reference in its entirety to the maximum extent allowable by law.

### TECHNICAL FIELD

The present disclosure relates generally to electronic systems and devices and, in particular, to the security of electronic systems and devices. More precisely, the present disclosure concerns a way secure of storing sensitive and non-sensitive data in a same memory.

### BACKGROUND

Currently, many electronic systems and devices may use sensitive data and non-sensitive data, and, for this purpose, may sometimes need to store the data in memories. For security purposes, it is important to store these sensitive and non-sensitive data separately.

It would be desirable to be able to improve, at least partly, certain aspects of the storage of sensitive data and non-sensitive in an electronic system.

There is a need for a more secure way of storing sensitive and non-sensitive data.

There is a need for a more secure way of storing sensitive and non-sensitive data in a same memory.

There is a need for a more secure way of storing first data that are accessible only to a first module and second data that are accessible only to a second module in a same memory.

There is a need for a device that is more compact.

There is a need for a device comprising only one memory instead of multiple memories.

There is a need to overcome all or part of the disadvantages of known methods for storing data in an electronic device.

There is a need to overcome all or part of the disadvantages of known electronic system capable of storing data.

There is a need to address all or some of the drawbacks of known methods for storing data in an electronic device.

There is a need to address all or some of the drawbacks of known electronic devices capable of storing data.

### SUMMARY

In an embodiment, an electronic device comprises a memory, wherein: first data that are only accessible to a first module are stored in a first group of columns of memory cells of said memory; and second data that are only accessible to a second module, different from the first module, are stored in a second group of columns of memory cells of said memory, said first and second groups of columns of memory cells being disjoint.

Another embodiment provides a method for storing, in a memory of an electronic device, first data that are only accessible to a first module and second data that are only accessible to a second module, different from the first module, the method comprising: storing said first data in a first group of columns of memory cells of said memory, and storing said second data in a second group of columns of memory cells of said memory, wherein said first and second groups of columns of memory cells are disjoint.

According to an embodiment, said first module is only capable of (in other words is restricted solely to) accessing said first group of columns.

According to an embodiment, said second module is only capable of (in other words is restricted solely to) accessing said second group of columns.

According to an embodiment, said first data are sensitive data, and the first module is a secure module.

According to an embodiment, said second data are non-sensitive data, and the second module is a non-secure module.

According to an embodiment, said device comprises a logical interface configured to manage the storage of said first and second data into said first and second groups.

According to an embodiment, at least third data that are only accessible to at least one third module are stored in at least a third group of columns of memory cells of said memory, said first, second and third groups of columns of memory cells being disjoint.

According to an embodiment, said at least one third module is only capable of (in other words is restricted solely to) communicating with said at least one third group of columns.

According to an embodiment, said memory is chosen in the group comprising: a volatile memory, a non-volatile memory, a random access memory, a read-only memory, a flash memory, a fuse memory.

According to an embodiment, said memory is a fuse memory.

According to an embodiment, said first and second groups of columns of memory cells are physically separated.

According to an embodiment, said first and second groups of columns of memory cells each have their own independent wiring system.

According to an embodiment, there is no connection between the independent wiring systems.

Another embodiment provides a memory configured to be the memory of an electronic device described previously.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates, in block form, an embodiment of an electronic device;

FIG. 2 illustrates, in block form, a memory of the embodiment of FIG. 1; and

FIG. 3 illustrates, in block form, another embodiment of an electronic device.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

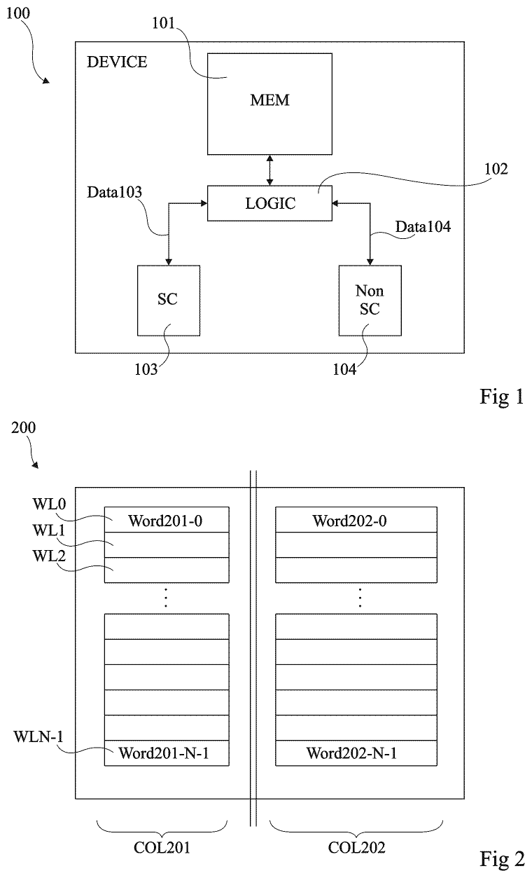

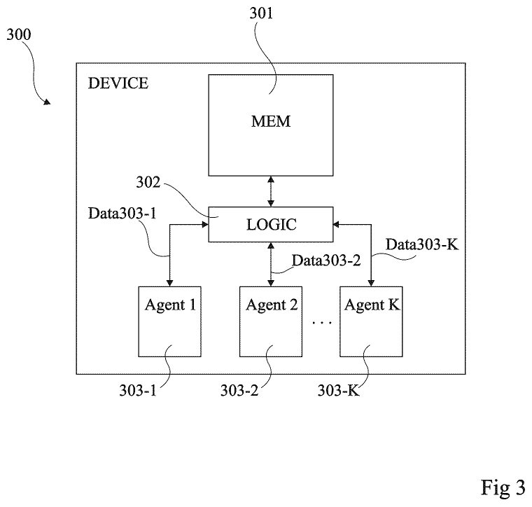

The above described embodiments concerns the storage of data in a memory of an electronic device, and more particularly, the storage of first data only accessible to a first module and of second data only accessible to a second module in a same main memory. In order to avoid the second module to have access to the first data, and vice versa, the main memory is divided into two secondary memories, each secondary memory corresponding to a group of columns of memory cells of the main memory. Such an embodiment is described in relation with FIGS. 1 and 2. Another embodiment wherein the main memory stores data of more than two (2) modules is described in relation with FIG. 3.

Moreover, the above described embodiments are particularly adapted to be used in any kind of industrial markets wherein storing data is necessary. More particularly, such electronic device and storing method can be intended for: the automotive industry, for example in the domain of car electrification or the domain of advanced driver assistance systems (ADAS); the industrial industry, for example in the domain of green energy, in the domain of electrification of infrastructure, of the internet of things (IoT), and of smart homes, wherein power and energy consumption and the exchange of data are key element; the personal electronics industry, for example in the domain of mobile phone and of the internet of things (IoT), and in the domain of high speed-interface; and the communications equipment, computers and peripherals industry, for example in the domain of infrastructure and data centers, and in the domain of satellites in low earth orbit.

Moreover, the above-described embodiments are particularly adapted to the automotive industry and the industrial market.

FIG. 1 represents, schematically and in block forms, an embodiment of an electronic device 100 (DEVICE).

According to an embodiment, electronic device 100 comprises a memory 101 (MEM) capable of storing data. According to an example, memory 101 may be of any type of memory, such as a volatile memory, a non-volatile memory, a random access memory, a read-only memory, a flash memory. According to a preferred embodiment, memory 101 is a fuse memory.

According to an example, electronic device 100 further comprises a logic interface 102 (LOGIC) associated with memory 101. Logic interface 102 is configured to provide data to and receive data from memory 101 through a secure connection. In other words, only logic interface 102 is capable of providing data to and receiving data from memory 101.

According to an embodiment, electronic device 100 further comprises a first module 103 (SC) and a second module 104 (Non SC), wherein each module is capable of storing data into the memory 101 via the logic interface 102. More particularly, modules 103 and 104 are totally independent. According to an embodiment, module 103 is capable of storing and accessing data Data103 into the memory 101 via interface 102. According to an embodiment, module 104 is capable of storing and accessing data Data104 into the memory 101 via interface 102.

According to an embodiment, data Data103 and Data104 are stored in two different parts of memory 101. A first part of memory 101 is defined by a first group of columns of memory cells of memory and may be referred, hereafter, as a first secondary memory. A secondary part of memory 101 is defined by a second group of columns of memory cells of memory and may be referred, hereafter, as a second secondary memory. According to an embodiment, the first and second groups of columns are disjoint, that is they have no common column. According to an embodiment, both first and second groups of columns can be of the same size, meaning having the same number of columns, or of different size, meaning having a different number of columns. According to an embodiment, each group of columns may comprise columns that are adjacent, but, according to a variant, each group of columns may comprise one or several columns that are not adjacent.

According to an embodiment, logic interface 102 comprises two communication links capable of providing data to and receiving data from module 103 and module 104. More particularly, logic interface 102 can receive and transfer data Data103 to module 103 via a first communication link, and can receive and transfer data Data104 to module 104 via a second communication link. Modules 103 and 104 only have the ability of providing data to and receiving data from the logic interface 102. It is described in more details in relation with FIG. 2 how data are stored into memory 101 by the logic interface 102.

According to an embodiment, a method for storing in a unique memory two sets of data that are each accessible to only one module is the following.

Module 103 stores data Data103 in the first group of columns of said memory. Module 104 stores data Data104 in the first group of columns of said memory. These storing operations are executed via the logic interface 102.

According to a preferred example, module 103 may be a secure (SC) module, meaning a module that is capable of handling sensitive data, and module 104 may be a non-secure module, meaning a module that is not trusted to handling sensitive data. In that case, the logic interface 102 ensure a safe storage of sensitive data and non-sensitive data in the same memory.

An advantage of this embodiment is to use only one memory instead of two memories. This is indeed an advantage, because, in certain cases, having two memories takes more space on a chip than having only one, due to several circuits associated to each memory. This is especially the case when the memory 101 is a fuse memory. Using two fuse memories takes indeed far more space than using only one fuse memory having the same storage capacity as two fuse memories, due to circuits associated with fuse memories.

FIG. 2 represents, schematically and in block forms, an example of memory 200 of the type of memory 101 described in relation with FIG. 1.

As described earlier, memory 200 may be of any type of memory, such as a volatile memory, a non-volatile memory, a random access memory, a read-only memory, a flash memory. According to a preferred embodiment, memory 200 is a fuse memory. Memory 200 comprises memory cells that are arranged into a matrix forms comprising N lines referenced WL0, WL1, . . . , WLN-1, N being an integer, and P columns, P being an integer.

As described earlier, memory 200 is divided into two disjoint parts constituting two secondary memories. A first part of memory 200 is defined by a first group of columns COL201 of memory 200 and may be referred, hereafter, as a first secondary memory. A second part of memory 200 is defined by a second group of columns COL202 of memory 200 and may be referred, hereafter, as a second secondary memory. The first group of columns COL201 is used for storing data of a first electronic module, and the second group of columns COL202 is used for storing data of a second electronic module that is different from the first module.

It is commonly said that a line of a memory stores a word of data. In the case of memory 200, it is considered that each line WL0, WL1, . . . , WLN-1 stores two words of data Word201-0, . . . , Word201-N-1, and Word202-0, . . . , Word202-N-1. A first word of data Word201-0, . . . , Word201-N-1 is stored in the first group of columns COL201, and the second word Word202-0, . . . , Word202-N-1 is stored in the second group of columns COL202. According to an embodiment, the first module only has access to the first words Word201-0, . . . , Word201-N-1, and the second module only has access to the second word Word202-0, . . . , Word202-N-1.

According to an embodiment, the two secondary memories of memory 200 are physically separated in memory 200 in order to avoid the leak of data between the two secondary memories. According to an example, each secondary memory may have its own independent wiring system in order to avoid leak of data, such that there is no physical wired datapath connecting data in group of column COL1 to anywhere except module 103, and there is no physical wired datapath connecting data in group of columns COL2 to anywhere except module 104. Said in other words, there is no connection between the independent wiring systems. According to another example, the logic interface may also have several independent wiring systems for each secondary memory.

According to an example, a logic interface, of the type of logic interface 102 described in relation with FIG. 2, is capable of managing the storing of data into memory 200. When data from a first module is received by the logic interface, it is capable of storing and accessing this data in the correct part of the memory.

FIG. 3 represents, schematically and in block forms, another embodiment of an electronic device 300 (DEVICE).

Electronic device 300 is similar to electronic device 100 described in relation with FIG. 1. Common elements and features of devices 100 and 300 are not described again in details here. Only differences between devices 100 and 300 are emphasized.

More precisely, similarly to device 100, device 300 comprises: a memory 301 of the type of memory 101; and a logic interface 302 of the type of logic interface 102.

Furthermore, device 300 comprises more than two electronic modules capable of storing data into memory 301 via the logic interface 302. More particularly, device 300 comprises K electronic modules 303-1 (Agent 1), 303-2 (Agent 2), . . . , 303-K (Agent K), K being an integer that is greater than two. According to an embodiment, modules 303-1 to 303-K are totally independent from each other. According to an embodiment, each module 303-k, k being an integer comprised between 1 to K, is capable of storing and accessing data Data303-k into the memory 301 via interface 302.

According to an embodiment, in that case data Data303-1, data Data303-2, . . . , and Data303-K are stored in K different parts of memory 301. Each part of memory is defined by a group of columns of memory cells. According to an embodiment, all the K groups of columns are disjoint, that is they have no common column. According to an embodiment, all groups of columns can be of the same size, meaning having the same number of columns, or of different sizes, meaning having a different number of columns. According to an embodiment, each group of columns may comprise columns that are adjacent, but, according to a variant, each group of columns may have one or several columns that are not adjacent.

According to an embodiment, logic interface 302 comprises K communication links capable of providing data to and receiving data from module 303-1 to 303-K. Modules 303-1 to 303-K only have the ability of providing data to and receiving data from the logic interface 302.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. An electronic device, comprising:
a memory including a first group of columns of memory cells of said memory and a second group of columns of memory cells of said memory, wherein said first and second groups of columns of memory cells are disjoint and wherein said first and second groups of columns of memory cells are physically separated;
a first module coupled to the memory, wherein first data only accessible to the first module are stored in the first group of columns of memory cells of said memory; and
a second module, different from the first module, coupled to the memory, wherein second data only accessible to the second module are stored in the second group of columns of memory cells of said memory.

2. The device according to claim 1, wherein said first module is only capable of accessing said first group of columns of memory cells, and wherein said second module is only capable of accessing said second group of columns of memory cells.

3. The device according to claim 1, wherein said first data are sensitive data, and wherein the first module is a secure module.

4. The device according to claim 3, wherein said second data are non-sensitive data, and wherein the second module is a non-secure module.

5. The device according to claim 1, further comprising a logical interface between the memory and the first and second modules, said logical interface configured to manage storage of said first and second data into said first and second groups of columns of memory cells.

6. The device according to claims 1, wherein the memory includes a third group of columns of memory cells of said memory, said first, second and third groups being disjoint, and further comprising a third module coupled to the memory, wherein third data only accessible to the third module are stored in the third group of columns of memory cells.

7. The device according to claim 6, wherein said third module is only capable of communicating with said third group of columns of memory cells.

8. The device according to claim 1, wherein said memory comprises one of: a volatile memory, a non-volatile memory, a random access memory, a read-only memory, or a flash memory.

9. The device according to claim 1, wherein said memory is a fuse memory.

10. The device according to claim 1, wherein said first and second groups of columns of memory cells have each their own independent wiring system.

11. The device according to claim 10, wherein there is no connection between the independent wiring systems.

12. The device according to claim 1, comprising:
a first physical wired datapath connection between the first module and the first group of columns of memory cells data;
a second physical wired datapath connection between the second module and the second group of columns of memory cells;
wherein the first and second physical wired datapaths are independent of each other.

13. An electronic device including the memory according to claim 1.

14. A method for storing, in a memory of an electronic device, first data that are only accessible to a first module and second data that are only accessible to a second module, different from the first module, the method comprising:
storing said first data in a first group of columns of memory cells of said memory; and
storing said second data are stored in a second group of columns of memory cells of said memory;
wherein said first and second groups of columns of memory cells are disjoint and wherein said first and second groups of columns of memory cells are physically separated.

15. The method according to claim 14, wherein said first data are sensitive data and the first module is a secure module, and wherein said second data are non-sensitive data and the second module is a non-secure module.

16. The method according to claim 14, wherein said first and second groups of columns of memory cells have each their own independent wiring system.

17. The method according to claim 16, wherein there is no connection between the independent wiring systems.

18. The method according to claim 14, further comprising: restricting said first module to only accessing said first group of columns of memory cells, and restricting said second module to only accessing said second group of columns of memory cells.

19. The method according to claim 14, wherein said memory comprises one of: a volatile memory, a non-volatile memory, a random access memory, a read-only memory, a flash memory.

20. The method according to claim 14, wherein said memory is a fuse memory.
